(19) United States
(12) Patent Application Publication
(10) Pub. No.: US 2016/0224503 A1
(43) Pub. Date: Aug. 4, 2016

(54) ADAPTIVE, PREDICATIVE, AND INTELLIGENT SCANNING OF ITEMS IN A PHYSICAL LAYER MANAGEMENT SYSTEM

(71) Applicant: CommScope Connectivity Belgium BVBA, Kessel-Lo (BE)

(72) Inventors: Christian Oscar Vanoverschelde, Horion-Hozemont (BE); Johan Geens, Bunsbeek (BE); Kristof Vastmans, Boutersem (BE)

(21) Appl. No.: 15/014,206

(22) Filed: Feb. 3, 2016

Related U.S. Application Data
(60) Provisional application No. 62/111,773, filed on Feb. 4, 2015.

(51) Int. Cl. G06F 13/40; G06F 11/30

(52) U.S. Cl. CPC G06F 13/4068; G06F 11/3051; G06F 11/3031

(57) ABSTRACT

One embodiment is directed to scanning a plurality of items in a physical layer management system using an adaptive, predicative, and intelligent scanning method.

### CROSS-REFERENCE TO RELATED APPLICATION

This application claims the benefit of U.S. Provisional Patent Application Ser. No. 62/111,773, filed on Feb. 4, 2015, which is hereby incorporated herein by reference.

### BACKGROUND

Various types of physical layer management (PLM) technology can be used to track connections made at the service ports of patch panels or other cross- or inter-connection devices.

One type of PLM technology makes use of an Electrically Erasable Programmable Read-Only Memory (EEPROM) or other storage device that is integrated with or attached to a connector on a cable. The storage device is used to store information about the connector or cable along with other information. The port (or other connector) into which the associated connector is inserted is configured so that the information stored in the EEPROM can be read when the connector is inserted into the port. Also, the PLM technology can be configured so that information can be written to the EEPROM when the connector is inserted into the port (for example, an insertion count can be updated and written to the EEPROM each time the connector is inserted into a port).

Another type of PLM technology makes use of so-called “ninth wire” technology. Ninth wire technology makes use of special cables that include an extra conductor or signal path (also referred to here as the “ninth wire”) that is used for determining which port each end of the cable is inserted into.

Yet another type of PLM technology makes use of radio frequency identification (RFID) tags and readers. With RFID technology, an RFID tag is attached to or integrated with a connector on a cable. The RFID tag is used to store information about the connector or cable along with other information. The RFID tag can be read after the associated connector is inserted into a corresponding jack or other port using an RFID reader.

Another type of PLM technology infers connection information by sensing when connectors are inserted and removed from ports of the various devices.

Such PLM technology typically includes some mechanism to determine the connection status of each service port of a device (for example, whether or not a connector attached to a cable is connected to that service port). A controller included in (or otherwise associated with) the device typically periodically checks the status of each service port. This is typically done in order to determine when the status of a service port has changed. When the controller determines that a connector attached to a cable has been connected to a service port that previously did not have a connector attached to it, the controller obtains information about the connector and/or the attached cable using the PLM technology included in the device.

In one common configuration, multiple managed devices are housed together in a single frame, rack, or other structure. In such a configuration, a hierarchal controller scheme is often used in which one controller is associated with the frame as a whole, and each managed device housed in that frame has an associated device controller. The frame controller communicates with the device controllers over a bus or individual point-to-point links. Each device controller checks the status of the ports of the managed device associated with that device controller and, when requested by the frame controller, informs the frame controller of any changes in the status of any of that device's ports.

Typically, the frame controller is able to request status information from only a single device controller at a time and uses a round-robin scheme to request status information from the device controllers, where the frame controller checks the device controllers in a predefined order and an equal number of times each round. Also, the order and number of times each device controller is checked does not change from round-to-round.

### SUMMARY

One embodiment is directed to a method of scanning a plurality of items in a physical layer management system. The method comprises assigning initial scan priorities to the items to be scanned and repeating the following: scanning the items in accordance with the assigned scan priorities, and dynamically updating the scan priorities assigned to the items to be scanned.

Another embodiment is directed to a managed frame that comprises a plurality of positions, each position configured to have a respective managed device installed therein. The managed frame further comprises a controller configured to scan the plurality of positions and any managed devices installed therein. The controller is configured to scan the plurality of positions and any managed devices installed therein using an adaptive scanning method.

Another embodiment is directed to a managed device that comprises a plurality of service ports, each service port configured to have at least one cable attached thereto. The managed device further comprises a controller configured to scan the plurality of service ports. The controller is configured to scan the plurality of service ports using an adaptive scanning method.

### DRAWINGS

FIG. 1A is a block diagram of one exemplary embodiment of a physical layer management system.

FIG. 1B is a block diagram illustrating details of the managed drawer shown in FIG. 1A. FIGS. 1A and 1B are collectively referred to here as “FIG. 1”.

FIG. 2 is a flow diagram of one exemplary embodiment of a method of scanning items in a physical layer management system in an adaptive, predictive, and intelligent manner.

FIG. 3 is a block diagram of one example of drawer software that can be used with the physical layer management system of FIG. 1.

FIG. 4 is a block diagram of one example of adapter pack software that can be used with the physical layer management system of FIG. 1.

### DETAILED DESCRIPTION

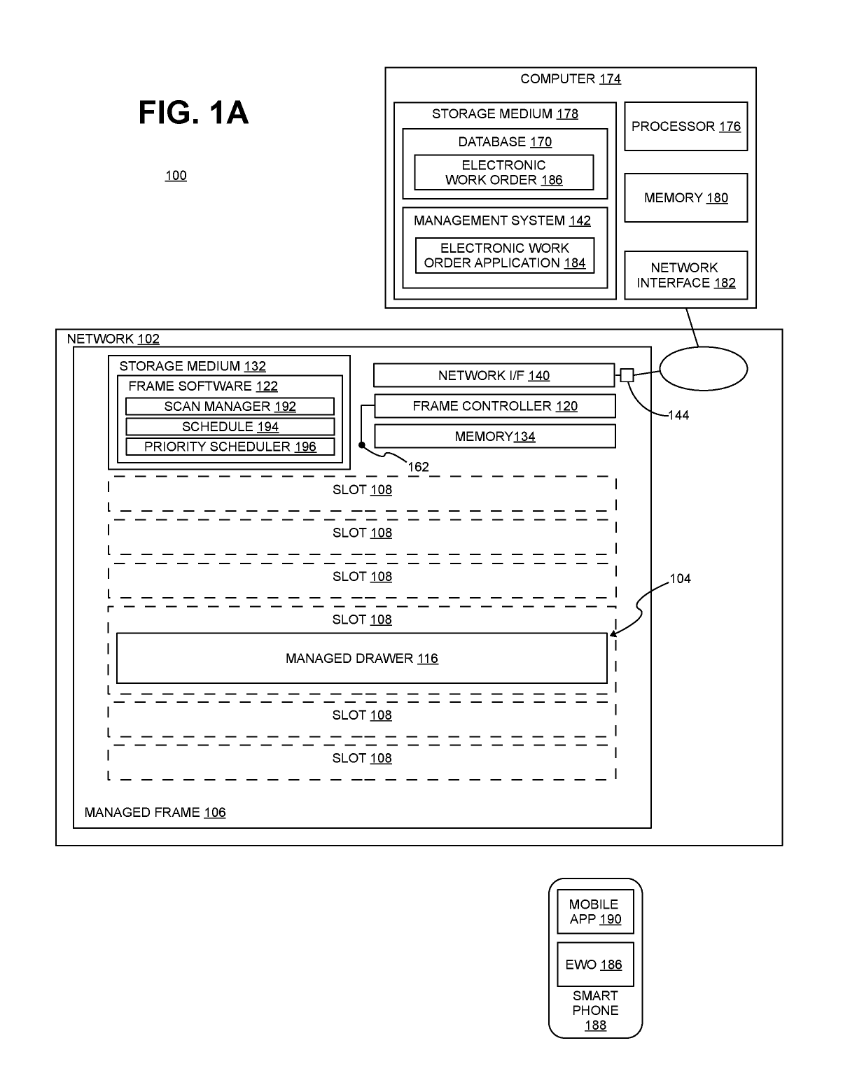

FIG. 1 is a block diagram of one exemplary embodiment of a system 100. The system 100 is also referred to here as a “physical layer management” (PLM) system 100.

In the exemplary embodiment shown in FIG. 1, the PLM system 100 is used to track physical layer information related to the network 102. As used herein, “physical layer information” comprises information about the cabling, connections, and communication links that exist in the network 102. The PLM system 100 is also used to guide technicians in moving, adding, or changing those connections.

In the exemplary embodiment shown in FIG. 1, the network 102 includes various network elements or devices to which cables can be connected. In the exemplary embodiment shown in FIG. 1, the network 102 includes a frame, rack, or other enclosure or structure 106 in which a plurality of managed network elements or devices 104 can be housed.

The managed frame 106 includes a plurality of positions or slots 108 in which managed devices 104 can be inserted or otherwise supported by the managed frame 106. Each of the managed devices 104 includes a plurality of ports to which cables 110 terminated with connectors 112 can be connected.

In the exemplary embodiment shown in FIG. 1, the managed frame 106 and the managed devices 104 are designed for use with fiber optic cables terminated with fiber optic connectors. In this exemplary embodiment, the frame 106 comprises an optical distribution frame or rack, and each of the managed devices 104 comprises one or more trays 114 housed within a drawer 116, where each tray 114 is designed to hold a plurality of fiber optic adapters 118. The drawers 116 and trays 114 are also referred to here as “managed drawers” 116 and “managed trays” 114, respectively. In FIG. 1, only one managed drawer 116 is shown for ease of illustration. Each tray 114 acts as a patch panel to connect patch cables entering one side of the tray 114 to another cable (such as a distribution cable or a feeder cable) entering another side of the tray 114. Examples of fiber optic connectors that can be used in such an embodiment include, without limitation, LC adapters, SC adapters, and multiple-fiber push-on/pull-off (MPO) connectors.

It is to be understood, however, that the techniques described here can be used with other types other types of adapters, cables, and connectors as well as with other types of managed devices 104. For example, the techniques described here can be used with other types of managed devices 104 that are designed for use with copper cables, such as copper twisted-pair CAT-5, CAT-6, and CAT-7 cables typically used to implement ETHERNET local area networks. Moreover, the managed device 104 can be implemented for use with other types of cables (for example, other types of copper cables or fiber optic cables). The managed device 104 can be implemented in other ways (for example, as a patch panel, splitter tray, switch, router, etc.).

In the exemplary embodiment described here in connection with FIG. 1, a hierarchal controller scheme is used. More specifically, in this exemplary embodiment, the managed frame 106 comprises a frame controller 120 that is configured to execute software 122 (also referred to here as “frame software” 122). Also, in this exemplary embodiment, each drawer 116 comprises at least one controller 124 (also referred to here as a “drawer controller” 124) that is configured to execute software 126 (also referred to here as “drawer software” 126). In this exemplary embodiment, each drawer 116 comprises a fixed portion 128 (such as a housing or other enclosure) and a moving or mobile portion 130 (such as a sliding shelf). The mobile portion 130 of each drawer 116 can be slid into a first position designed for compact and secure storage of the drawer 116 (and the trays 114 included therein) and moved into a second position designed for ease of access to the cables 110 and adapters 118 connected to the associated trays 114. For example, the mobile portion 130 can be slid into and out of the fixed portion 128 of each drawer 116.

In the particular embodiment shown in FIG. 1, each drawer 116 comprises a single drawer controller 124 that is packaged on the fixed portion 128 of the drawer assembly (for example, on a printed circuit board). In this embodiment, each drawer controller 124 is communicatively coupled to the frame controller 120. For example, each of the drawer controllers 124 can be communicatively coupled to the frame controller 120 over a backplane included in the managed frame 106.

The frame software 122 comprises program instructions that are stored (or otherwise embodied) on or in an appropriate non-transitory storage medium or media 132 (such as flash or other non-volatile memory, magnetic disc drives, and/or optical disc drives) from which at least a portion of the program instructions are read by the frame controller 120 for execution thereby. Although the storage media 132 is shown in FIG. 1 as being included in, and local to, the managed frame 106, it is to be understood that remote storage media (for example, storage media that is accessible over the network 102) and/or removable media can also be used. The managed frame 106 also includes memory 134 for storing the program instructions (and any related data) during execution by the frame controller 120. Memory 134 comprises, in one implementation, any suitable form of random access memory (RAM) now known or later developed, such as dynamic random access memory (DRAM). In other embodiments, other types of memory are used.

Likewise, for each drawer 116, the drawer software 126 for that drawer 116 comprises program instructions that are stored (or otherwise embodied) on or in an appropriate non-transitory storage medium or media 136 (such as flash or other non-volatile memory, magnetic disc drives, and/or optical disc drives) from which at least a portion of the program instructions are read by the associated drawer controller 124 for execution thereby. Although each storage media 136 is shown in FIG. 1 as being included in, and local to, the respective drawer 116, it is to be understood that remote storage media (for example, storage media that is accessible over the network 102) and/or removable media can also be used. Each drawer 116 also includes memory 138 for storing the program instructions (and any related data) during execution by the drawer controller 124. Memory 138 comprises, in one implementation, any suitable form of random access memory (RAM) now known or later developed, such as dynamic random access memory (DRAM). In other embodiments, other types of memory are used.

The managed frame 106 also includes a network interface 140 for communicatively coupling the frame controller 120 (and the software 122 executing thereon) to the network 102 and, ultimately, a management system 142. In the example shown in FIG. 1, the frame controller 120 and the network interface 140 are communicatively coupled to the network 102 and the management system 142 by including a respective “management” or “non-service” port 144 in the managed frame 106. The management port 144 is separate from the “service” ports 146 of the drawers 116. However, it is to be understood that it is possible for the frame controller 120 in the managed frame 106 to be communicatively coupled to the network 102 using one or more of the service ports 146, with the understanding that doing so limits the ability of the management system 142 to monitor and manage those service ports 146 (for example, in the event that any such service port 146 fails or a cable 110 is removed from any such service port 146, the frame controller 120 would not be able to access the network 102 in order for the frame controller 120 to inform the management system 142 of that fact).

In the exemplary embodiment shown in FIG. 1, the service ports 146 comprise a plurality of adapters 110 that are packaged together in an adapter pack 148. In this embodiment, each tray 114 comprises one or more positions 158 in which one or more of adapter packs 148 can be installed (only one of which is shown in FIG. 1 for ease of illustration). In the exemplary embodiment described here in connection with FIG. 1, each adapter pack 148 comprises at least one controller 150 (also referred to here as an “adapter pack controller” 150) that is configured to execute software 152 (also referred to here as “adapter pack software” 152).

For each adapter pack 148, the adapter pack software 152 for that adapter pack 148 comprises program instructions that are stored (or otherwise embodied) on or in an appropriate non-transitory storage medium or media 154 (such as flash or other non-volatile memory, magnetic disc drives, and/or optical disc drives) from which at least a portion of the program instructions are read by the associated adapter pack controller 150 for execution thereby. Although each storage media 154 is shown in FIG. 1 as being included in, and local to, the respective adapter pack 148, it is to be understood that remote storage media (for example, storage media that is accessible over the network 102) and/or removable media can also be used. Each adapter pack 148 also includes memory 156 for storing the program instructions (and any related data) during execution by the adapter pack controller 150. Memory 156 comprises, in one implementation, any suitable form of random access memory (RAM) now known or later developed, such as dynamic random access memory (DRAM). In other embodiments, other types of memory are used.

Each adapter pack controller 150 in a given drawer 116 is coupled to the corresponding drawer controller 124. For example, each drawer controller 124 (and the corresponding storage medium 136 and memory 138) can be packaged on a fixed drawer printed circuit board positioned in the fixed portion 128 of the corresponding drawer 116. This fixed drawer printed circuit board can include an appropriate connector or other interface to communicatively couple the drawer controller 124 to the backplane of the frame 106 and, ultimately, to the frame controller 120. Also, in this example, each drawer 116 can include a mobile drawer printed circuit board positioned in the mobile portion 130 of the drawer 116. The fixed and mobile drawer printed circuit boards for each drawer 116 can include appropriate connectors or other interfaces to communicatively the fixed drawer printed circuit board to the mobile drawer printed circuit board using, for example, a flat, flexible cable. In this example, each tray 114 includes a respective tray printed circuit board positioned in the tray 114. Each such tray printed circuit board can include an appropriate connector or other interface to communicatively couple that tray printed circuit board to the mobile drawer printed circuit board.

Also, in this example, each adapter pack 148 can include a respective adapter pack printed circuit board that houses the adapter pack controller 150 (and the corresponding storage medium 154 and memory 156). Each such adapter pack printed circuit board can include an appropriate connector or other interface to communicatively couple that adapter pack printed circuit board to the tray printed circuit board. The drawer controller 124 in each drawer 116 is able to communicate with the adapter pack controller 150 included in each adapter pack 148 housed in that drawer 116 via the mobile drawer printed circuit board and the corresponding tray printed circuit board and adapter pack printed circuit board (and the corresponding connectors and interfaces). In this example, each tray 114 is configured to house multiple adapter packs 148, and each tray printed circuit board include an appropriate connector or other interface to communicatively couple that tray printed circuit board to each adapter pack printed circuit board housed within the corresponding tray 114.

The mobile drawer printed circuit board can also optionally include another drawer controller that is programmed to serve as a protocol interface between the main drawer controller 120 and each adapter pack controller 150. Likewise, each tray printed circuit board can include an optional tray controller that is programmed to serve as a protocol interface between the drawer controllers and each adapter pack controller 150. It is be understood, however, that with appropriate programming of the main drawer controller 120 and/or the adapter pack controllers 150, either or both of the secondary drawer controller or the tray controller need not be used.

In some exemplary implementations of this embodiments, the service ports 146 comprises LC adapters 118, into which LC connectors 112 attached to cables 110 can be inserted. In some exemplary implementations of this embodiment, the management port 144 comprises an RJ-45 jack that is included in the managed frame 106 and into which a copper twisted-pair CAT-5, CAT-6, or CAT-7 cable terminated with an RJ-45 plug can be inserted.

Each managed device 104 includes one or more visual indicators 162. In this exemplary embodiment, each visual indicator 162 is implemented using a light emitting diode (LED), and each visual indicator 162 is also referred to here as “LED” 162.

In this embodiment, at least some of the visual indicators 162 are associated with the service ports 146 of each drawer 116 so that a visual indication can be provided in order to assist a technician in locating a particular service port 146 of that drawer 116.

Also, in this embodiment, at least one LED or other visual indictor 162 is positioned on the managed frame 106, each of the drawers 116, and each adapter pack 148 in order to provide a visual indication to assist a technician in locating a particular managed frame 106, drawer 116, or adapter pack 148, respectively.

In this exemplary embodiment, each LED or other visual indicator 162 is coupled to one or more of the controllers in the managed frame 106 so that the one or more controllers (more specifically, software executing on the controllers) can control that visual indictor 162, typically under the control of the frame controller 120.

In this example, each adapter pack 148 can also include a plurality of port-presence sensors 164, each of which is configured for use by an adapter pack controller 150 in determining if a cable 110 is connected to the associated service port 146. Also, port-presence information can be used to infer information about connections made using the drawer 116 instead of or in addition to using information read from storage devices 168 (described below) attached to cables 110.

In this example, each adapter pack 148 also includes, for each of the service ports 146, a corresponding storage-device interface 166 that is configured so that, when a cable 110 is connected to that service port 146, information can be read from any storage device 168 attached to the cable 110. The information can be read by the corresponding adapter pack controller 150 and communicated to the drawer controller 124 and the frame controller 120 and ultimately to the management system 142, which stores and/or updates information in a database or other data store 170 maintained by the management system 142.

In one example, each storage-device interface 166 comprises a contact-based storage device interface that is configured for use in reading information from and/or writing information to an Electrically Erasable Programmable Read-Only Memory (EEPROM) attached to each cable. That is, in such an EEPROM example, contact-based interfaces are used for reading information from and/or writing information to the storage devices 168 attached to the cables 110 and each storage device 168 is implemented using an EEPROM.

In another example, each storage-device interface 166 comprises a radio frequency identifier (RFID) interface that is configured for use in reading information from an RFID tag attached to a cable 110. That is, in such an RFID example, contact-less interfaces are used for reading information from the storage devices 168 attached to the cables 110 and each storage device 168 is implemented using an RFID tag.

Each of the drawers 116 can also include an optional drawer open sensor 172 that is configured to determine if that drawer 116 has been opened (or the mobile portion 130 has been lifted or slid out of the fixed portion 128) so that its service ports 146 can be accessed. Also, each of the drawers 116 can include an optional drawer opening control 173 that is configured to open the drawer 116 (or unlock or otherwise permit the drawer 116 to be opened).

Power can be supplied to the active components of the managed frame 106 and managed devices 104 in various ways (for example, by connecting the frame 106 and devices 104 to the standard AC power grid, using Power-Over-Ethernet technology, or in other ways).

Also, the managed frame 106, managed drawers 116, and adapter packs 148 can include respective storage devices (not shown) for storing identification and other information associated with the frames 106, drawers 116, and adapter packs 148. The frame controllers 120, drawer controllers 124, and adapter packs 150, respectively, can read these storage devices, respectively, and can communicate the information that is read to the management system 142.

In the exemplary embodiment shown in FIG. 1, the management system 142 is implemented as software that executes on one or more computers 174. In the exemplary embodiment shown in FIG. 1, each computer 174 comprises one or more programmable processors 176 for executing the software. The software comprises program instructions that are stored (or otherwise embodied) on or in an appropriate non-transitory storage medium or media 178 (such as flash or other non-volatile memory, magnetic disc drives, and/or optical disc drives) from which at least a portion of the program instructions are read by the programmable processor 176 for execution thereby. Although the storage media 178 is shown in FIG. 1 as being included in, and local to, the respective computer 174, it is to be understood that remote storage media (for example, storage media that is accessible over the network 102) and/or removable media can also be used. Each computer 174 also includes memory 180 for storing the program instructions (and any related data) during execution by the programmable processor 176. Memory 180 comprises, in one implementation, any suitable form of random access memory (RAM) now known or later developed, such as dynamic random access memory (DRAM). In other embodiments, other types of memory are used. Each computer 174 also includes one or more network interfaces 182 for communicatively coupling the computer 174 to the network 102.

In the example shown in FIG. 1, the management system 142 further includes an electronic work order application 184. The electronic work application 184 is used to construct electronic work orders 186. Each electronic work order 186 specifies one or more steps that are to be carried out by a technician at a particular location. For example, an electronic work order 186 can indicate that one or more connections implemented using the service ports 146 of the drawers 116 should be added, removed, and/or changed. For steps that involve adding, removing, and/or changing connections made at the service ports 146 of the drawers 116, the information that is read from the associated storage devices 168 and communicated to the management system 142 can be used by the electronic work order application 184 to verify that the specified connection has been added, removed, and/or changed correctly.

As described in more detail below, the visual indicators 162 associated with the service ports 146 of the drawers 116 and the other parts of the managed frame 106 can be actuated in order to guide a technician in carrying out the steps of electronic work orders 186.

In this example, each electronic work order 186 is communicated to a portable device 188 that is carried by a technician that has been assigned to carry out that electronic work order 186. In this example, the portable device 188 is implemented using a smartphone (and is also referred to here as “smartphone” 188). However, it is to be understood that each portable device 188 can be implemented in other ways (for example, using tablet computers, laptop computers, or similar devices).

In this example, each smartphone 188 is configured to execute a mobile application 190. The mobile application 190 is configured to communicate with the electronic work order application 184 and the management system 142 and to receive the electronic work orders 186. The mobile application 190 comprises program instructions that are stored (or otherwise embodied) on or in an appropriate non-transitory storage medium or media from which at least a portion of the program instructions are read by at least one programmable processor included in the smartphone 188 for execution thereby.

Each electronic work order 186 can be communicated wirelessly to a smartphone 188 over the Internet (for example, via a cellular or wireless local area network to which the smartphone 188 is wirelessly connected). Each electronic work order 186 can also be communicated to the smartphone 188 in other ways (for example, using a wired connection with the smartphone 188).

Items in the physical layer management system 100 of FIG. 1 can be scanned or polled in an adaptive, predictive, and intelligent manner, as opposed to simply using a simple round-robin scheme.

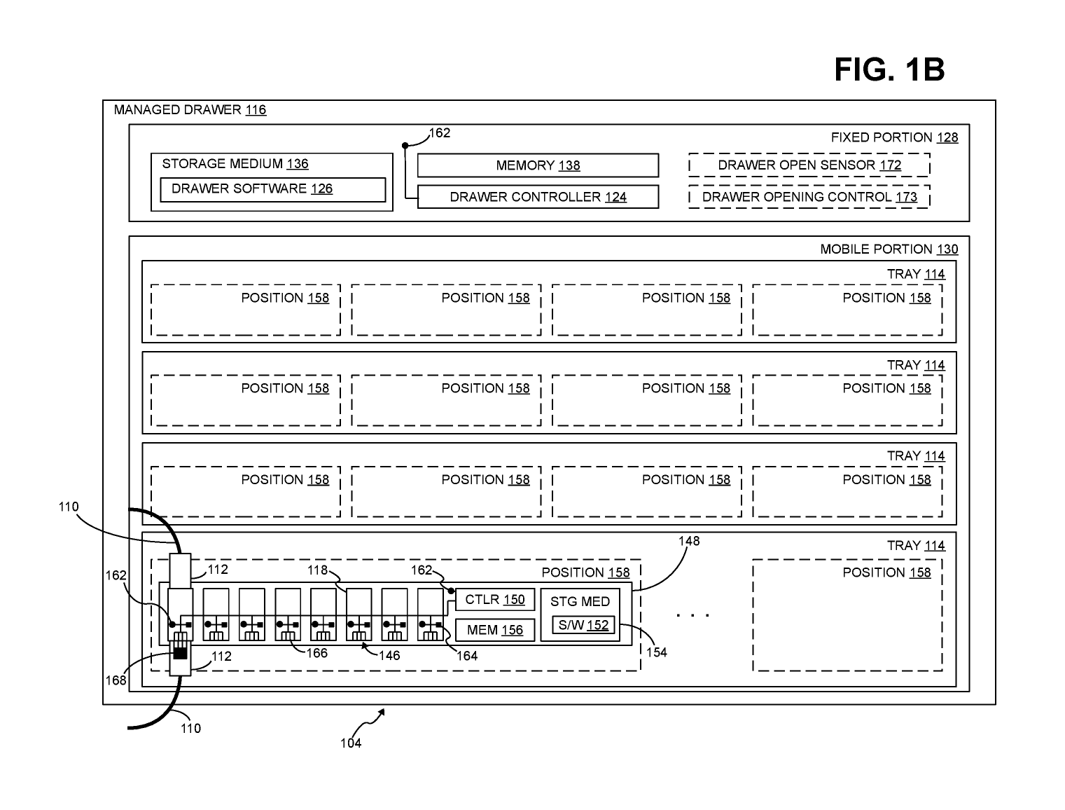

FIG. 2 is a flow diagram of one exemplary embodiment of a method 200 of scanning items in a physical layer management system in an adaptive, predictive, and intelligent manner. As used herein, an “item” to be scanned refers to anything in the physical layer management system that needs to be polled or scanned. Also, as used herein, “scanning” an item refers to checking, and/or obtaining information about, a status, event, action, and/or information associated with that item.

One example is the scanning of any managed drawers 116 installed in the slots 108 of the managed frame 106 of the PLM system 100 shown in FIG. 1, which are scanned by the frame controller 120. Another example is the scanning of any adapter packs 148 installed in a given drawer 116, which are scanned by the corresponding drawer controller 124. Another example is the scanning of the service ports 146 included in a given adapter pack 148, which are scanned by the corresponding adapter pack controller 150. Other examples are possible.

The blocks of the flow diagram shown in FIG. 2 have been arranged in a generally sequential manner for ease of explanation; however, it is to be understood that this arrangement is merely exemplary, and it should be recognized that the processing associated with method 200 (and the blocks shown in FIG. 2) can occur in a different order (for example, where at least some of the processing associated with the blocks is performed in parallel and/or in an event-driven manner).

Method 200 comprises assigning initial scan priorities to each of the items to be scanned (block 202). The scan priority that is assigned to each item indicates how often that item is to be scanned.

Method 200 further comprises scanning the items in accordance with the currently assigned scan priorities (block 204) and dynamically updating the scan priorities assigned to the items (block 206). The processing associated with blocks 204 and 206 is generally repeated.

The scan priorities that are assigned to the items can be updated based on various factors. In one exemplary embodiment, the scan priorities are updated based on whether any activities or events are expected to occur in the near future at any of the items to be scanned. In such an embodiment, if any activity or an event is expected to occur in the near feature at a particular item, the scan priority of that item can be increased to the highest scan priority so that item can be scanned more frequently.

Some examples of when an event or activity is expected to occur at an item in the near term includes when a requested action that affects that item is pending, when an electronic work order that affects that item is being performed, when a technician has accessed that item, or when an event has occurred recently at that item or at a related item.

In one exemplary embodiment where the items to be scanned are the managed drawers 116 installed in the managed frame 106 of the PLM system 100 shown in FIG. 1, when a given managed drawer 116 is opened, the drawer-open sensor 172 for that managed drawer 116 will detect this event. When this occurs, it is likely that some activity involving that managed drawer 116 (such as moving, adding, or changing a connection at a service port 146 of the managed drawer 116) is expected to occur in the short term.

An event is expected to occur at a managed drawer 116 in the near term in other situations. For example, if a technician using a smartphone 188 has started working on an electronic work order 186 that includes one or more steps that involve some activity being performed at a given managed drawer 116 (such as moving, adding, or changing a connection at a service port 146 of the managed drawer 116), the mobile application 190 will inform the management system 142 of that fact. In turn, the management system 142 will inform the frame controller 120 which managed drawers 116 can expect to have an event occur at them in connection with the electronic work order 186.

Also, in one exemplary embodiment, if a predetermined amount of time elapses without any activity or events occurring at a particular item, the scan priority assigned to that item can be reduced so that item is checked less frequently. This is also referred to as “timing out”. By doing this, it makes it possible to scan higher priority items more frequently.

The adaptive, predictive, and intelligent scanning method described above can reduce the latency between activity or an event occurring at an item in the physical layer management system 100 and that activity or event being detected and reported to the management system 142. This is especially useful in high-density applications having a large number of items need to be scanned.

In one exemplary embodiment, the adaptive, predictive, and intelligent scanning method described above is used in the PLM system 100 shown in FIG. 1 (though it is to be understood that other embodiments can be implemented in other ways). More specifically, in this exemplary embodiment, the processing of method 200 is performed by the frame controller 120 that is included in the managed frame 106 to scan any managed drawers 116 installed in the slots 108 of the managed frame 106.

In this exemplary embodiment, the frame software 122 executing on the frame controller 120 includes a scan manager 192 that is configured to scan any managed drawers 116 installed in the slots 108 of the managed frame 106 in accordance with a schedule 194. The frame software 122 executing on the frame controller 120 includes a priority scheduler 196 that is configured to continuously determine which priority should be assigned to each item to be scanned and to update the schedule 194 used by the scan manager 192 to determine which item should be scanned at any particular point in time.

In general, the schedule 194 defines successive schedule “periods.” Each schedule period includes a series of time slots, where one item is “scanned” during each time slot. In the exemplary embodiment described here, a managed drawer 116 installed in a slot 108 of the managed frame 106 (if there is one) is scanned during each time slot of the schedule period. As noted below, in this exemplary embodiment, the size of the schedule periods (that is, the number of time slots included in the schedule periods) is dynamic.

When the scan manager 192 executing on the frame controller 120 scans any managed drawer 116 installed in a particular slot 108 of the managed frame 106, the scan manager 192 attempts to communicate over the backplane of the managed frame 106 with a drawer controller 124 for any managed drawer 116 installed in that slot 108. If there is no managed drawer 116 installed in that particular slot 108, the scan manager 192 will be not able to communicate with such a drawer controller 124 and eventually the attempt to communicate will time out. When this happens, the scan manager 192 determines that there is no managed drawer 116 installed in that particular slot 108.

If there is a managed drawer 116 installed in that particular slot 108, the scan manager 192 obtains information about the managed drawer 116 and the service ports 146 for that managed drawer 116. This information can include information about any events or status changes that have occurred since the last time the scan manager 192 scanned that managed drawer 116 and/or can include information about the current status of all of the service ports 146 and the managed drawer 116 (and the trays 114 and adapter packs 148 installed therein). For example, the scan manager 192 can instruct the drawer software 126 executing on that drawer controller 124 to send information about any events or status changes that have occurred since the last time the scan manager 192 scanned that managed drawer 116. In this exemplary embodiment, the drawer software 126 is configured to obtain information about the current status of all of the service ports 146 in the corresponding drawers 116.

In general, in this exemplary embodiment, for each adapter pack 148 in a given drawer 116, the adapter pack software 152 executing on the corresponding adapter pack controller 150 scans each service port 146 in that adapter pack 148. The adapter pack software 152 scans a service port 146 by first checking the port-presence sensor 164 for that service port 146 to determine if a cable 110 is connected to that service port 146. If a cable 110 is connected to that service port 146, the adapter pack software 152 uses the storage-device interface 166 for that service port 146 to read any storage device 168 attached to the cable 110 connected that service port 146. In this exemplary embodiment, the adapter pack software 152 scans the service ports 146 in the associated adapter pack 148 using a round robin scheme. However, it is to be understood that an adaptive, predictive, and intelligent scheme similar to the one described here for scanning the slots 108 and drawers 116 can be used for scanning the service ports 146 of the adapter packs 148. The adapter pack software 152 communicates the information it obtains to the drawer controller 124 for the drawer 116 in which that adapter pack 148 is installed.

As noted above, the scan manager 192 uses the schedule 194 to determine which item to scan during each time slot. The priority scheduler 196 assigns each managed drawer 116 in the managed frame 106 a scan priority and then schedules the managed drawers 116 for scanning based on the assigned scan priorities. The scan priorities assigned to the managed drawers 116 installed in the managed frame 106 indicate how often each managed drawer 116 should be scanned.

The following description refers to scanning a managed drawer 116 in the managed frame 106. However, it is to be understood that a slot 108 of the managed frame 106 may not actually have a managed drawer 116 installed in it. Therefore, references to “scanning a managed drawer 116” in a particular slot 108 of the managed frame 106 should be understood as meaning attempting to scan any managed drawer 116 that is installed in that slot 108, where the attempt will fail if no managed drawer 116 is actually installed in that slot 108 and that failure serves as an indication that no managed drawer 116 is installed in that slot 108. Also, the following description refers to assigning scan priorities to the managed drawers 116 in the managed frame 106. However, as noted above, a slot 108 of the managed frame 106 may not actually have a managed drawer 116 installed in it. Therefore, references to assigning scan priorities to the managed drawer 116 in the managed frame 106 should be understood as meaning assigning scan priorities to the slots 108 of the managed frame 106, where the scan priority assigned to a particular slot 108 is also assigned to any managed drawer 116 installed in that slot 108.

The priority scheduler 196 continually updates the scan priorities that are assigned to the managed drawer 116 of the managed frame 106 based on various factors.

In general, events that occur at the managed drawer 116 installed in the managed frame 106 (as well as any of empty slots 108) can be classified into two general classes: predictable events and unpredictable events. Examples of predictable events include events that are performed pursuant to an electronic work order 186 or that are otherwise scheduled or requested to be performed by the management system 142 or events that occur after another event has occurred at that item or a related item (such as an event that occurs at a tray soon after the associated drawer has been opened or an event that occurs at a drawer or a tray soon after that drawer or tray has been inserted). Examples of unpredictable events include when a connector 112 is inserted into an incorrect port 146 or when some element in the system 100 fails.

In the exemplary embodiment described above in connection with FIG. 1, most events tend to be predictable (or become predictable after a previous unpredictable event).

The priority scheduler 196 is configured so that most of the scanning time is concentrated on scanning for predictable events (that is, scanning managed drawer 116 where some event is expected to occur in the short term).

In the exemplary embodiment described here where the items to be scanned are managed drawers 116 installed in the slots 108 of the managed frame 106 shown in FIG. 1, four scan priorities can be used. These scan priorities are: “level 3,” “level 2,” “level 1,” and “level 0,” where “level 3” corresponds to the lowest priority, “level 0” corresponds to the highest priority, and “level 2” is considered the “normal” or “standard” scan priority. Also, in this exemplary embodiment, each slot 108 and associated managed drawer 116 assigned the level-0 scan priority is checked significantly more often than the slots 108 and managed drawers 116 assigned the other scan priorities.

For example, each slot 108 and managed drawer 116 assigned the level-0 scan priority can be checked 6 times during every scan round, each slot 108 and managed drawer 116 assigned the level-1 scan priority can be checked 2 times during every scan round, each managed drawer 116 assigned the level-2 scan priority is checked once per scan round, and each slot 108 assigned the level-3 scan priority is checked only once during a predetermined number of scan rounds.

In this exemplary embodiment, when an event or activity is expected to occur at a managed drawer 116 or slot 108 in the near term, that managed drawer 116 or slot 108 is immediately assigned the level-0 scan priority, regardless of the scan priority currently assigned to that managed drawer 116 or slot 108.

For example, an event is expected to occur at a managed drawer 116 or a slot 108 in the near term when an event has occurred recently at that managed drawer 116 or slot 108. Also, in this exemplary embodiment, an event is expected to occur at a managed drawer 116 or slot 108 in the near term when a requested action involving that managed drawer 116 or slot 108 is currently pending.

One example of a requested action that involves a managed drawer 116 or empty slot 108 is where an electronic work order 186 includes one or more steps that involve some action being performed at that managed drawer 116 or slot 108 (such as moving, adding, or changing a connection at a service port 146 of the managed drawer 116 or installing a managed drawer 116 into an empty slot 108). Such a requested action is “pending” when a technician goes to where the managed frame 106 is located and uses the mobile application 190 on a smartphone 188 to inform the management system 142 when the technician is ready to perform the steps of the electronic work order 186. In response, the management system 142 will inform the frame controller 120 which managed drawers 116 and slots 108 can expect to have an event occur at them in connection with the electronic work order 186 in the near term. As a result of this, the priority scheduler 196 will update the scan priority assigned to those managed drawers 116 and slots 108 to be the level-0 scan priority (if the managed drawers 116 and slots 108 are not already assigned the level-0 scan priority) and update the schedule 194 used by the scan manager 192. After the technician has successfully completed all of the steps of the electronic work order 186 or uses the mobile application 190 on a smartphone 188 to inform the management system 142 that the technician is no longer working on that electronic work order 186, the requested action is no longer considered to be pending.

In this exemplary embodiment, for a managed drawer 116 or slot 108 that is currently assigned the level-0 scan priority, when a predetermined amount of time (also referred to here as the “level-0 timeout period”) elapses without any event occurring at that managed drawer 116 or slot 108, that managed drawer 116 or slot 108 “times out “of the level-0 scan priority and is assigned the level-1 scan priority.

Likewise, in this exemplary embodiment, for a managed drawer 116 or slot 108 that is currently assigned the level-1 scan priority, when a predetermined amount of time (also referred to here as the “level-1 timeout period”) elapses without any event occurring at that managed drawer 116 or slot 108, that managed drawer 116 or slot 108 times out of the level-1 scan priority and is assigned the level-2 scan priority unless the relevant item is an empty slot 108, in which case the empty slot 108 is immediately assigned the level-3 scan priority.

It is to be understood that these four scan priorities and the conditions for transitioning between priorities are examples only and that other scan priorities and transition conditions can be used.

The initial scan priorities are assigned to the managed drawers 116 and slots 108 of the managed frame 106 by the priority scheduler 196 after system power up. After system power up, the frame controller 120 checks each slot 108 to determine if a managed drawer 116 is installed in that slot 108 (for example, by attempting to communicate over the backplane with a drawer controller 124 for any managed drawer 116 installed in that slot 108). Then, the priority scheduler 196 assigns an initial scan priority to each slot 108 (and any installed managed drawer 116) based on whether or not a managed drawer 116 is installed in that slot 108, where empty slots 108 are assigned the level-3 scan priority and managed drawers 116 installed in the managed frame 106 are assigned the level-2 scan priority. It is to be understood, however, that the initial scan priorities can be assigned in other ways.

In the exemplary embodiment described here (where the items to be scanned are the managed drawers 116 installed in the managed frame 106 (and any empty slots 108) of the PLM system 100 shown in FIG. 1), the scan manager 192 determines which managed drawer 116 or empty slot 108 is scanned during each time slot in accordance with the schedule 194, which is dynamically updated by the priority scheduler 196. The priority scheduler 196 can use any suitable scheduling approach that is able to satisfy the constraints that are established for the system.

In this exemplary embodiment, the priority scheduler 196 continually and dynamically updates the scan priorities that are assigned to the managed drawers 116 and the empty slots 108 and dynamically updates the schedule 194. This is done based on various factors. In this exemplary embodiment, the priority scheduler 196 inserts additional time slots into the current and/or subsequent schedule periods if necessary to satisfy the various scheduling constraints described here.

The priority scheduler 196 dynamically manages the assigned scan priorities and the values of the various timeout periods so that the vast majority (for example, at least 90 percent) of the managed drawers 116 and slots 108 are assigned the two lowest scan priorities (that is, level 2 and level 3), with only small number of managed drawers 116 or slots 108 assigned the two highest scan priorities (that is, level 0 and level 1).

The adaptive, predictive, and intelligent scanning method described above can reduce the latency between an event occurring at a service port 146 of a managed drawer 116 and that event being detected by the associated controllers and reported to the management system 142. This is especially useful in high-density applications where a frame controller 120 has to scan a large number of managed drawers 116 (and their associated service ports 146).

Although the adaptive, predictive, and intelligent scanning method is described above as being used by the frame controller 120 to scan the drawer controllers 124 of the managed drawers 116 installed in the managed frame 106, it is to be understood that the same technique can be used by a controller to scan other items in the system 100, such as the service ports 146.

For example, in another exemplary embodiment implemented using the system 100 of FIG. 1, the drawer controller 124 in each managed drawer 116 uses the adaptive, predictive, and intelligent scanning method described here to scan any adapter packs 148 installed in that drawer 116. In such an embodiment, four scan priorities similar to the ones described above can used. It is to be understood that these four scan priorities are examples only and that other scan priorities can be used.

When the drawer controller 124 scans any adapter pack 148 installed in a particular adapter-pack position 158 of the managed drawer 116, the drawer controller 124 attempts to communicate with an adapter pack controller 150 of any adapter pack 148 installed in that position 158. If there is no adapter pack 148 installed in that particular adapter-pack position 158 in the drawer 116, the drawer controller 124 will be not able to communicate with such an adapter pack controller 150 and eventually the attempt to communicate will time out. When this happens, the drawer controller 124 determines that there is no adapter pack 148 installed in that particular adapter-pack position 158. If there is an adapter pack 148 installed in that adapter-pack position 158, the drawer controller 124 obtains information about the adapter pack 148 and the service ports 146 for that adapter pack 148.

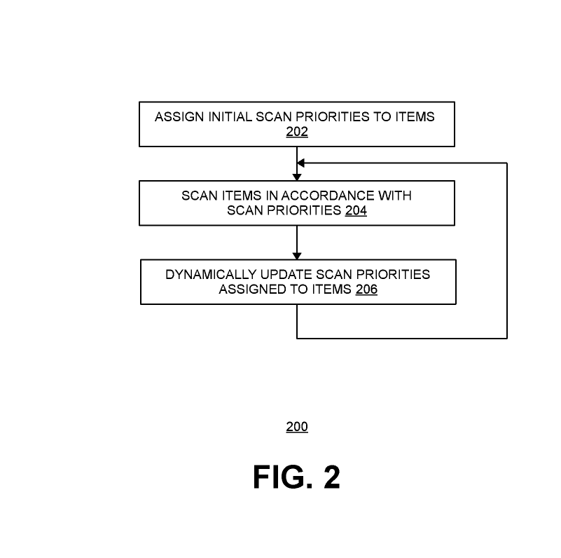

FIG. 3 is a block diagram of one example of drawer software 126 suitable for use in this exemplary embodiment. As shown in FIG. 3, in this exemplary embodiment, the drawer software 126 executing on the drawer controller 124 in each managed drawer 116 includes a scan manager 189 that is configured to scan the adapter packs 148 in accordance with a schedule 191. The drawer software 126 executing on the drawer controller 124 includes a priority scheduler 193 that is configured to continuously determine which priority should be assigned to each item to be scanned and to update the schedule 191 used by the scan manager 189 to determine which item should be scanned at any particular point in time.

In such an embodiment, the initial scan priorities can be assigned to the adapter-pack positions 158 in the drawer 116 (and any adapter packs 148 installed therein) by the priority scheduler 193 after system power up. After system power up, the drawer controller 124 attempts to communicate with an adapter pack controller 150 of any adapter pack 148 installed in each adapter-pack position 158 to determine if an adapter pack 148 is installed in that adapter-pack position 158. Then, the priority scheduler 193 assigns an initial scan priority to each adapter pack 148 and adapter-pack position 158 based on whether or not an adapter pack 148 is installed in that adapter-pack position 158. It is to be understood, however, that the initial scan priorities can be assigned in other ways.

In this exemplary embodiment, the scan manager 189 determines which adapter pack 148 and adapter-pack position 158 is scanned during each time slot in accordance with the schedule 191, which is dynamically updated by the priority scheduler 193. The priority scheduler 193 can use any suitable scheduling approach that is able to satisfy the constraints that are established for the system. In this exemplary embodiment, the priority scheduler 193 continually and dynamically updates the scan priorities that are assigned to each adapter pack 148 and adapter-pack position 158 and dynamically updates the schedule 191. This is done based on various factors. In this exemplary embodiment, the priority scheduler 193 inserts additional time slots into the current and/or subsequent schedule periods if necessary to satisfy the various scheduling constraints described here.

In another exemplary embodiment implemented using the system 100 of FIG. 1, one or more of the adapter pack controllers 150 in the trays 114 of the managed drawers 116 can use the adaptive, predictive, and intelligent scanning method described here to scan the service ports 146 of the associated adapter pack 148. In such an embodiment, four scan priorities similar to the ones described above can used. It is to be understood that these four scan priorities are examples only and that other scan priorities can be used. The adapter pack controller 150 scans a service port 146 by first checking the port-presence sensor 164 for that service port 146 to determine if a cable 110 is connected to that service port 146. If a cable 110 is connected to that service port 146, the adapter pack controller 150 uses the storage-device interface 166 for that service port 146 to read any storage device 168 attached to the cable 110 connected that service port 146.

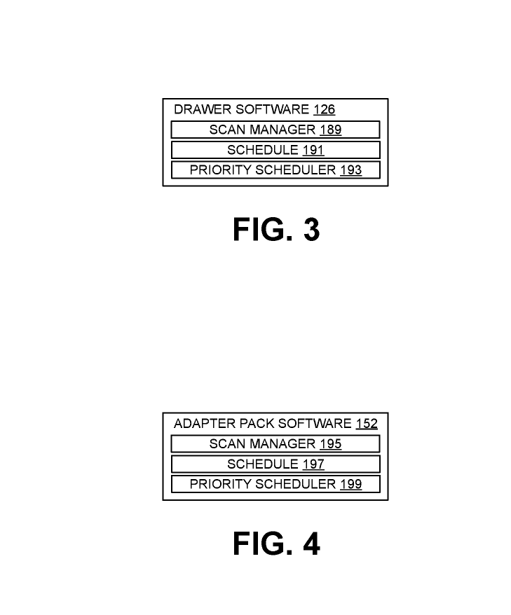

FIG. 4 is a block diagram of one example of adapter pack software 152 suitable for use in this exemplary embodiment. As shown in FIG. 4, in this exemplary embodiment, the adapter pack software 152 executing on the adapter pack controller 150 in each adapter pack 148 includes a scan manager 195 that is configured to scan the service ports 146 in accordance with a schedule 197. The adapter pack software 152 executing on the adapter pack controller 150 includes a priority scheduler 199 that is configured to continuously determine which priority should be assigned to each item to be scanned and to update the schedule 197 used by the scan manager 195 to determine which item should be scanned at any particular point in time.

In such an embodiment, the initial scan priorities can be assigned to the service ports 146 of the adapter pack 148 by the priority scheduler 199 after system power up. After system power up, the adapter pack controller 150 checks each service port 146 to determine if a cable 110 is connected to it using the associated port-presence sensor 164. Then, the priority scheduler 199 assigns an initial scan priority to each service port 146 based on whether or not a cable 110 is connected to that service port 136. It is to be understood, however, that the initial scan priorities can be assigned in other ways.

In this exemplary embodiment, the scan manager 195 determines which service port 146 is scanned during each time slot in accordance with the schedule 197, which is dynamically updated by the priority scheduler 199. The priority scheduler 199 can use any suitable scheduling approach that is able to satisfy the constraints that are established for the system. In this exemplary embodiment, the priority scheduler 199 continually and dynamically updates the scan priorities that are assigned to the service ports 146 and dynamically updates the schedule 197. This is done based on various factors. In this exemplary embodiment, the priority scheduler 199 inserts additional time slots into the current and/or subsequent schedule periods if necessary to satisfy the various scheduling constraints described here.

Other embodiments can be implemented in other ways.

A number of embodiments have been described. Nevertheless, it will be understood that various modifications to the described embodiments may be made without departing from the spirit and scope of the claimed invention.

### EXAMPLE EMBODIMENTS

Example 1 includes a method of scanning a plurality of items in a physical layer management system, the method comprising: assigning initial scan priorities to the items to be scanned; and repeating the following: scanning the items in accordance with the assigned scan priorities; and dynamically updating the scan priorities assigned to the items to be scanned.

Example 2 includes the method of Example 1, wherein dynamically updating the scan priorities assigned to the items to be scanned comprises increasing the scan priority assigned to an item to be scanned if an event is expected to occur at that item in the near term.

Example 3 includes the method of Example 2, wherein an event is expected to occur at an item in the near term if a requested action that affects that managed device is pending.

Example 4 includes any of the methods of Examples 2-3, wherein an event is expected to occur at an item in the near term if an electronic work order that affects that item is being performed.

Example 5 includes any of the methods of Examples 2-4, wherein an event is expected to occur at that item in the near term if a technician has accessed that item.

Example 6 includes any of the methods of Examples 2-5, wherein an event is expected to occur at that item in the near term when an event has occurred recently at that item or at a related item.

Example 7 includes any of the methods of Examples 1-6, wherein dynamically updating the scan priorities assigned to the items to be scanned comprises decreasing the scan priority assigned to an item to be scanned if the priority assigned to the item has timed out.

Example 8 includes any of the methods of Examples 1-7, wherein the items to be scanned comprises slots or positions of a rack or frame and any devices installed in the slots or positions of the rack or frame.

Example 9 includes any of the methods of Examples 1-8, wherein the items to be scanned comprise port-presence sensors associated with service ports of a device.

Example 10 includes a managed frame comprising: a plurality of positions, each position configured to have a respective managed device installed therein; a controller configured to scan the plurality of positions and any managed devices installed therein, wherein the controller is configured to scan the plurality of positions and any managed devices installed therein using an adaptive scanning method.

Example 11 includes the managed frame of Example 10, wherein the controller is configured to scan the plurality of positions and any managed devices installed therein using an adaptive and predictive scanning method.

Example 12 includes any of the managed frames of Examples 10-11, wherein the controller is configured to: assign initial scan priorities to the positions to be scanned; and repeat the following: scan the positions in accordance with the assigned scan priorities; and dynamically update the scan priorities assigned to the positions to be scanned.

Example 13 includes the managed frame of Example 12, wherein the controller is configured to dynamically update the scan priorities assigned to the positions to be scanned by increasing the scan priority assigned to a position to be scanned if an event is expected to occur at a managed device installed at that position in the near term.

Example 14 includes the managed frame of Example 13, wherein an event is expected to occur at a managed device installed at a position in the near term if a requested action that affects that managed device is pending.

Example 15 includes any of the managed frames of Examples 13-14, wherein an event is expected to occur at a managed device installed at a position in the near term if an electronic work order that affects that managed device is being performed.

Example 16 includes any of the managed frames of Examples 13-15, wherein an event is expected to occur at a managed device installed at a position in the near term if a technician has accessed that managed device.

Example 17 includes any of the managed frames of Examples 12-16, wherein the controller is configured to dynamically update the scan priorities assigned to the positions to be scanned by decreasing the scan priority assigned to a position to be scanned if the priority assigned to the position has timed out.

Example 18 includes a managed device comprising: a plurality of service ports, each service port configured to have at least one cable attached thereto; a controller configured to scan the plurality of service ports, wherein the controller is configured to scan the plurality of service ports using an adaptive scanning method.

Example 19 includes the managed device of Example 18, wherein the controller is configured to scan the plurality of service ports using an adaptive and predictive scanning method.

Example 20 includes any of the managed devices of Examples 18-19, wherein the controller is configured to: assign initial scan priorities to the service ports to be scanned; and repeat the following: scan the service ports in accordance with the assigned scan priorities; and dynamically update the scan priorities assigned to the service ports to be scanned.

Example 21 includes the managed device of Example 20, wherein the controller is configured to dynamically update the scan priorities assigned to the service ports to be scanned by increasing the scan priority assigned to a service port to be scanned if an event is expected to occur at that service port in the near term.

Example 22 includes the managed device of Example 21, wherein an event is expected to occur at a service port in the near term if a requested action that affects that managed device is pending.

Example 23 includes any of the managed devices of Examples 21-22, wherein an event is expected to occur at a service port in the near term if an electronic work order that affects that service port is being performed.

Example 24 includes any of the managed devices of Examples 21-23, wherein an event is expected to occur at a service port in the near term when an event has occurred recently at that item or at a related item.

Example 25 includes any of the managed devices of Examples 20-24, wherein the controller is configured to dynamically update the scan priorities assigned to the service ports to be scanned by decreasing the scan priority assigned to a service port to be scanned if the priority assigned to that service port has timed out.

1. A method of scanning a plurality of items in a physical layer management system, the method comprising:
assigning initial scan priorities to the items to be scanned; and
repeating the following:
scanning the items in accordance with the assigned scan priorities; and
dynamically updating the scan priorities assigned to the items to be scanned.

2. The method of claim 1, wherein dynamically updating the scan priorities assigned to the items to be scanned comprises increasing the scan priority assigned to an item to be scanned if an event is expected to occur at that item in the near term.

3. The method of claim 2, wherein an event is expected to occur at an item in the near term if a requested action that affects that managed device is pending.

4. The method of claim 2, wherein an event is expected to occur at an item in the near term if an electronic work order that affects that item is being performed.

5. The method of claim 2, wherein an event is expected to occur at that item in the near term if a technician has accessed that item.

6. The method of claim 2, wherein an event is expected to occur at that item in the near term when an event has occurred recently at that item or at a related item.

7. The method of claim 1, wherein dynamically updating the scan priorities assigned to the items to be scanned comprises decreasing the scan priority assigned to an item to be scanned if the priority assigned to the item has timed out.

8. The method of claim 1, wherein the items to be scanned comprises slots or positions of a rack or frame and any devices installed in the slots or positions of the rack or frame.

9. The method of claim 1, wherein the items to be scanned comprise port-presence sensors associated with service ports of a device.

10. A managed frame comprising:
a plurality of positions, each position configured to have a respective managed device installed therein;
a controller configured to scan the plurality of positions and any managed devices installed therein, wherein the controller is configured to scan the plurality of positions and any managed devices installed therein using an adaptive scanning method.

11. The managed frame of claim 10, wherein the controller is configured to scan the plurality of positions and any managed devices installed therein using an adaptive and predictive scanning method.

12. The managed frame of claim 10, wherein the controller is configured to:
assign initial scan priorities to the positions to be scanned; and
repeat the following:
scan the positions in accordance with the assigned scan priorities; and
dynamically update the scan priorities assigned to the positions to be scanned.

13. The managed frame of claim 12, wherein the controller is configured to dynamically update the scan priorities assigned to the positions to be scanned by increasing the scan priority assigned to a position to be scanned if an event is expected to occur at a managed device installed at that position in the near term.

14. The managed frame of claim 13, wherein an event is expected to occur at a managed device installed at a position in the near term if a requested action that affects that managed device is pending.

15. The managed frame of claim 13, wherein an event is expected to occur at a managed device installed at a position in the near term if an electronic work order that affects that managed device is being performed.

16. The managed frame of claim 13, wherein an event is expected to occur at a managed device installed at a position in the near term if a technician has accessed that managed device.

17. The managed frame of claim 12, wherein the controller is configured to dynamically update the scan priorities assigned to the positions to be scanned by decreasing the scan priority assigned to a position to be scanned if the priority assigned to the position has timed out.

18. A managed device comprising:
a plurality of service ports, each service port configured to have at least one cable attached thereto;
a controller configured to scan the plurality of service ports, wherein the controller is configured to scan the plurality of service ports using an adaptive scanning method.

19. The managed device of claim 18, wherein the controller is configured to scan the plurality of service ports using an adaptive and predictive scanning method.

20. The managed device of claim 18, wherein the controller is configured to:
assign initial scan priorities to the service ports to be scanned; and
repeat the following:
scan the service ports in accordance with the assigned scan priorities; and
dynamically update the scan priorities assigned to the service ports to be scanned.

21. The managed device of claim 20, wherein the controller is configured to dynamically update the scan priorities assigned to the service ports to be scanned by increasing the scan priority assigned to a service port to be scanned if an event is expected to occur at that service port in the near term.

22. The managed device of claim 21, wherein an event is expected to occur at a service port in the near term if a requested action that affects that managed device is pending.

23. The managed device of claim 21, wherein an event is expected to occur at a service port in the near term if an electronic work order that affects that service port is being performed.

24. The managed device of claim 21, wherein an event is expected to occur at a service port in the near term when an event has occurred recently at that item or at a related item.

25. The managed device of claim 20, wherein the controller is configured to dynamically update the scan priorities assigned to the service ports to be scanned by decreasing the scan priority assigned to a service port to be scanned if the priority assigned to that service port has timed out.
